(19) United States
(12) Patent Application Publication
(10) Pub. No.: US 2013/0226983 A1
(43) Pub. Date: Aug. 29, 2013

(54) Collaborative Video Highlights

(71) Applicants: Jeffrey Martin Beining, Sunrise, FL (US); Rodrigo Valentin Martinez, Marietta, GA (US); Ronnie Paskin, Ft. Lauderdale, FL (US)

(72) Inventors: Jeffrey Martin Beining, Sunrise, FL (US); Rodrigo Valentin Martinez, Marietta, GA (US); Ronnie Paskin, Ft. Lauderdale, FL (US)

(21) Appl. No.: 13/409,098

(22) Filed: Feb. 29, 2012

(51) Int. Cl. G06F 15/16

(52) U.S. Cl. 709/201

(57) ABSTRACT

A highlight server receives a highlight request from a client. The highlight request includes identification of media content and characteristics which a highlight stream is to be based on. The highlight server retrieves the media content identified in the highlight request. Based on the characteristics identified in the highlight request and characteristics associated with a user of the client and stored on the highlight server, the highlight server identifies a plurality of appropriate highlights from the retrieved media content. A highlight stream is generated from the plurality of appropriate highlights and transmitted to the client.

### BACKGROUND

1. Field of Art

The disclosure generally relates to the field of generating video highlights.

2. Description of Art

Web-based delivery of video content has become an increasingly popular form of content delivery for many content providers. For example, a number of content providers offer digital video content that can be streamed to network-enabled devices such as personal computers, television set-top boxes and mobile devices (e.g., smart phones). Many potential viewers do not want to watch a broadcast (such as a long sports event) in its entirety, but may nevertheless be interested in highlights which allow the user to quickly and conveniently view important or exciting portions of the broadcast. Traditionally, highlight reels are manually composed by content providers which results in some limitations. First, due to licensing agreements, content providers may have a limited time period during which they can stream highlights to a user. Furthermore, manual selection of highlights is time-consuming and reduces the time that the highlights will be available to the user. Additionally, the content provider may not customize the content according to the interests of the user.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates an embodiment of a computing environment for generating and streaming collaborative video highlights to one or more clients.

FIG. 2 illustrates a detailed view of a client according to one embodiment.

FIG. 3 illustrates a detailed view of the highlight server according to one embodiment.

FIG. 4 illustrates a detailed view of the content server according to one embodiment.

FIG. 5 illustrates an embodiment of a process for requesting a highlight stream from the highlight server for playback on a client.

FIG. 6 illustrates an embodiment of a process for generating a highlight stream on the highlight server and streaming the highlight stream to a client.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will be made in detail to several embodiments, examples of which are illustrated in the accompanying figures. It is noted that wherever practicable similar or like reference numbers may be used in the figures and may indicate similar or like functionality. The Figures depict embodiments of the disclosed system (or method) for purposes of illustration only. One skilled in the art will readily recognize from the following description that alternative embodiments of the structures and methods illustrated herein may be employed without departing from the principles described herein.

### Overview of Example Embodiments

A first example embodiment includes a computer-implemented method for generating video highlights and streaming the video highlights to a client. A highlight server receives a plurality of tagged highlight periods. Each of the plurality of tagged highlight periods identifying a time-localized segment of media content. The highlight server receives a highlight request for a highlight stream from a client, the highlight request includes an identifier of requested media content. User profile information pertaining to the user of the client is identified. The highlight server determines a user-requested highlight period for inclusion in the highlight stream generated from the requested media content based on the user profile information. The user-requested highlight period is selected from the plurality of tagged highlight periods. The highlight server generates the highlight stream from the requested media content based on the user-requested highlight period and transmits the highlight stream to the client.

Thus, the method beneficially provides a custom highlight stream for a particular user that contains only highlights of a requested media item (e.g., a video) that will be particularly relevant to that user based on his/her user profile.

### System Architecture

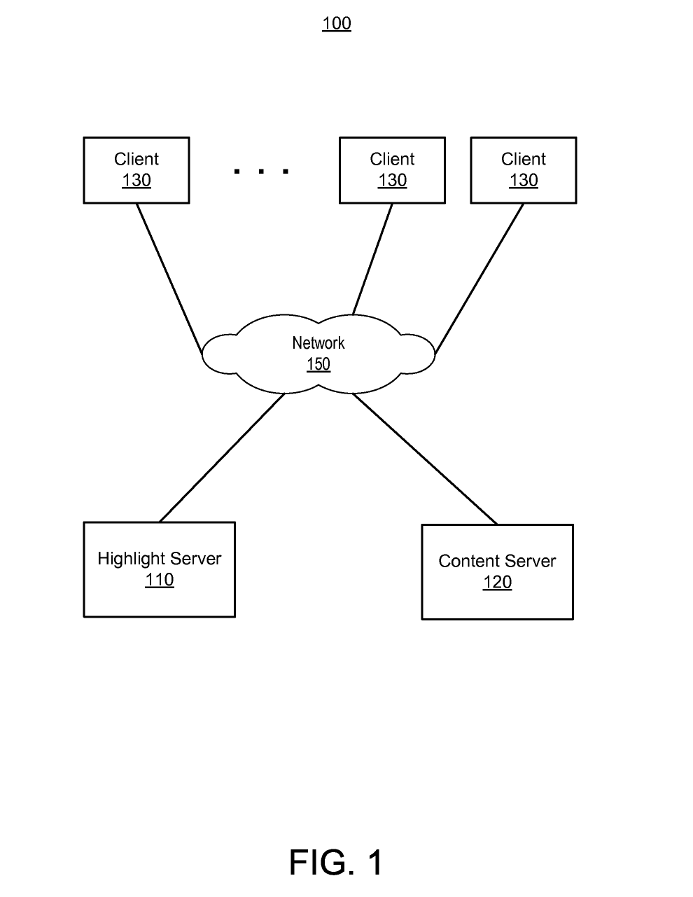

FIG. 1 is a high level block diagram illustrating an example computing environment 100 for generating video highlights according to one embodiment. A highlight server 110 and a content server 120 are coupled to each other and/or one or more clients 130 via a network 150. Only a single instance of the highlight server 110 and the content server 120 are shown along with three clients 130 in FIG. 1 in order to simplify and clarify the description. However, embodiments of the computing environment 100 can have thousands or millions of clients 130 as well as multiple highlight servers 110 and/or content servers 120. Furthermore, in one embodiment, the highlight server 110 and the content server 120 may be combined in a common server architecture.

The network 150 enables communications among the entities connected to it. In one embodiment, the network 150 is the Internet and uses standard communications technologies and/or protocols. At least a portion of the network 150 can comprise a mobile (e.g., cellular or wireless) data network such as those provided by wireless carriers, for example, VERIZON, AT&T, T-MOBILE, SPRINT, O2, VODAPHONE, and other wireless carriers. In some embodiments, the network 150 comprises a combination of communication technologies. The network 150 can include links using technologies such as Ethernet, 802.11, worldwide interoperability for microwave access (WiMAX), long term evolution (LTE), 3G, 4G, digital subscriber line (DSL), asynchronous transfer mode (ATM), InfiniBand, PCI Express Advanced Switching, etc. Similarly, the networking protocols used on the network 150 can include multiprotocol label switching (MPLS), transmission control protocol/Internet protocol (TCP/IP), User Datagram Protocol (UDP), hypertext transport protocol (HTTP), hypertext transfer protocol secure (HTTPS), simple mail transfer protocol (SMTP), file transfer protocol (FTP), etc. The data exchanged over the network 150 can be represented using technologies and/or formats including hypertext markup language (HTML) (e.g., HTML 5), extensible markup language (XML), etc. In addition, all or some of links can be encrypted using encryption technologies such as the secure sockets layer (SSL), transport layer security (TLS), virtual private networks (VPNs), Internet Protocol security (IPsec), etc. In another embodiment, the entities use custom and/or dedicated data communications technologies instead of, or in addition to, the ones described above.

The content server 120 provides media content to authorized clients 130. For example, in one embodiment, the content server 120 receives a request for a particular content segment. The content server 120 provides the requested segment to the requesting client 130. The content server 120 receives raw media (e.g., a media file such as a video file or a live audio/video input) from a content source and processes the raw media to generate a format suitable for streaming. In one embodiment, the raw media is a sporting event that is streamed live to one or more clients 130. For example, in one embodiment, the content server 120 processes media to enable HTTP Live Streaming (HLS) of the content. In one embodiment, the content server 120 breaks the raw media into a sequence of smaller HTTP-based downloadable files. Various other streaming protocols other than HLS may be used in other embodiments such as for example, FLASH-based streaming. In one embodiment, content server 120 may further transcode the media data to a standardized format. Furthermore, the content server 120 may create a plurality of parallel streams for the raw media file with each stream corresponding to at least one different encoding parameter. For example, the content server 120 may generate two or more streams of the content with each stream having a different bit rate. This allows, for example, different clients 130 to access different versions of the same media content depending on the particular configuration of the client 130 (e.g., memory and/or processing power) and the current network conditions (e.g., available network bandwidth).

In addition to storing and streaming media as originally received from a content source, the content server 120 may store and stream highlights generated by the highlight server 110. In one embodiment, highlight information is received from the highlight server 110 and stored as raw media in a highlight database.

The client 130 comprises an electronic device such as a personal computer, a laptop, mobile phone or smartphone, a tablet computer personal digital assistant (PDA) a television set-top box, etc. The client 130 executes a media player that is adapted to play media streams. When viewing a media stream, the client 130 allows a user to tag highlight periods of the media being streamed to the client. In one embodiment, the highlight period identifies a portion of the media stream deemed important by the user. For example, during a sporting event, the client 130 may tag a portion of the video during which a golfer makes a hole in one (e.g., by specifying a start time and an end time). The client 130 transmits tagged highlight periods to the highlight server 110.

In one embodiment, a user profile stored on the highlight server 110 is associated with each of the clients 130. In one embodiment, a user profile stores user profile information comprising a plurality of characteristics associated with a user or client. A characteristic may be an identification of a person, actor, athlete, team, sport, action, or any other indication of an entity or action within a portion of media. Rather than requesting a media stream of media content in its original format as provided by a content source, the client 130 may request from the highlight server 110 a highlight stream associated with an instance of media content. A highlight stream comprises a plurality of highlight periods from one or more instances of media content. The highlight stream may be customized according to the user profile associated with the client 130. Additionally, media content from which highlight streams are generated may be live events that are in progress and have not been completed at the time of highlight stream generation. For example, highlight streams may be generated from baseball games while the baseball game is in progress from the portion of the baseball game that has already occurred. In one embodiment, highlight streams generated from live events are available for streaming only during a certain time period. For example, a highlight stream generated from a live event may be available for four hours beyond the conclusion of the live event.

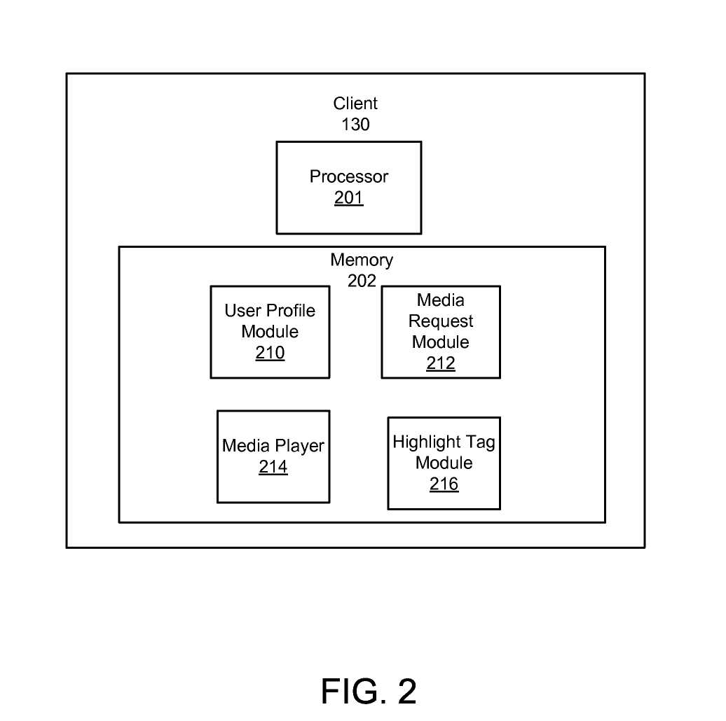

FIG. 2 illustrates a detailed view of a client 130 according to one embodiment. The client 130 comprises a processor 201 and a memory 202 according to one embodiment. The memory 202 stores modules comprising computer-executable program instructions executed by the processor to achieve the functionality attributed to the modules. In one embodiment, the modules in the memory 202 comprise a user profile module 210, a media request module 212, a media player 214 and a highlight tag module 216. In alternative embodiments, different or additional components may be included.

The media player 214 is configured to receive a video stream or highlight stream from the content server 120 or highlight server 110 and display them on the client 130. For example, in one embodiment, the media player 214 is embodied as computer program instructions stored to a computer-readable storage medium. When executed, the computer program instructions are loaded in a memory of the client 130 and executed by a processor of the client 130 to carry out the functions of the media player described herein. In one example embodiment, the media player 214 is embedded or otherwise accessed from a mobile application executing on a mobile device. Alternatively, the media player may be an embedded media player within a web page loaded by a web browser. In one embodiment, the modules described herein may be implemented as tabs, windows and web pages included in a web interface or embedded player in a mobile application. In yet another embodiment, the media player may be an application executing on a television set-top box or similar device. In one embodiment, the media player is implemented using Objective C in an HTML 5 environment, although in other embodiments different implementations may be used such as Javascript.

The user profile module 210 provides a user interface for obtaining characteristics associated with a user of the client 130, and providing these characteristics to the highlight server 110. For example, in one embodiment, a user provides login information that is stored on the highlight server 110 and allows the user to log in to the highlight server 110 using any of the clients 130. After login and authentication of the user, the user profile module 210 may enable the user to enter information to various profile fields that are stored on the highlight server 110 and associated with the user. For example, a user may provide their favorite sports teams, sports players, actors/actresses, age, location, alma mater, or other personal information. In one embodiment, the user profile module 210 allows the user to modify associated characteristics stored on the highlight server 110 at a later time.

In addition to accepting manual input of user characteristics, the user profile module 210 may enable the user to input account information that allows the user profile module 210 to retrieve characteristics of the user from social networks such as FACEBOOK, TWITTER and GOOGLE+. Many social networks allow users to identify favorite or preferred items including, musical artists, movies, sports, sports teams and hobbies. These preferred items retrieved from a social network account associated with the user may then be transmitted to the highlight server 110 by the characteristic module 210 and anonymously associated with the user as characteristics for further use. Characteristics may also be associated with a stored video, highlight stream or portion within a video or highlight stream. In one embodiment, if a characteristic is shared by a user on a social network and a portion of a video, the portion of the video is considered pertinent to the user and may be included in a highlight stream.

The media request module 212 provides an interface for enabling a user to request media content stored on the content server 120. For example, the media request module 212 may provide a directory of available content (sorted, for example, alphabetically, by category, date, etc.) and/or may provide a search tool for locating content based on keywords. In one embodiment, a user may use the media request module 212 to request content as originally provided by a content source. For example, television show episodes, movies, sporting events and other media may be requested from the content server 120 in their entirety. The user may also use the media request module 212 to request highlight streams from the highlight server 110. In one embodiment, the media request module 212 enables a user to identify a specific piece of media content and request an associated highlight stream. For example, the user may request highlights related to a specific sporting event or television show episode. Alternatively, the user may simply request highlights that the system will deem relevant to the user based on information stored in the user profile such as a favorite sports team or athlete.

In one embodiment, the media player 214 includes a sliding time bar visually displaying the length of a video and the current playback location within the video. In one embodiment, the sliding time bar includes identifiers of sections that have been frequently tagged by users in highlight periods. For example, if a large number (e.g., above a predefined threshold) of users create a highlight period at a temporal location in a video where a team scores a touchdown, the location of the large number of tagged highlight periods may be visually indicated on the sliding time bar. This visual indication enables convenient request of a highlight at that location or further highlight period tagging at that location. Additionally, in one embodiment, a plurality of highlight periods may be visually indicated on the sliding time bar. A user may filter the highlight periods that are displayed on the sliding time bar based on characteristics associated with the highlight periods. For example, in viewing a football game, a large number (e.g., above a predefined threshold) of users who associate with a particular team may have tagged a particular highlight periods (e.g., when points are scored by their team). These highlight periods may then be associated with that team. A different user may then filter the highlight periods so that tagged highlight periods associated with a particular team (e.g., “San Francisco 49ers”) are visually indicated on the sliding time bar. Alternatively, tagged highlight periods relevant to the user may be automatically determined based on the user's profile, and relevant highlights are visually indicated on the sliding time bar.

Highlight tag module 216 provides an interface enabling a user of the client 130 to tag a highlight period of a video that is being streamed to the client 130. In one embodiment, the highlight tag module 216 is integrated with the media player 214, thus enabling a user to tag highlights while viewing the video using an integrated interface. For example, in one embodiment, the highlight tag module 216 operates in conjunction with a time indicator of the media player 214 (e.g., a sliding time bar or a text-based time display) that allows the user to easily identify a point in time of a video stream. In one embodiment, the highlight tag module 216 is provides an interface enabling the user to enter a start and stop time of a highlight period, either via a text input or by selecting time locations along a time bar associated with the streamed video. In one embodiment, the user may enter only a start time of a highlight period and the highlight tag module 216 sets the stop time at a default increment beyond the start time of the highlight period. Additionally, in one embodiment, highlight tag module 216 retrieves a plurality of characteristics associated with the user from the highlight server 110 and presents them to the user. The user may select one or more of the characteristics that are related to the selected highlight period. For example, the user may be presented with plurality of sports, teams or players that they indicate preference for on a social network. The user may then select one of these, for example, Tiger Woods, to associate with the selected highlight period. Additionally, the user may enter keywords or other metadata that should be associated with the selected highlight period. The highlight tag module 216 is configured to transmit a representation of the selected highlight period(s) to the highlight server 110. For example, in one embodiment, the selected highlight period is represented by an identifier identifying the video, a start time for the highlight, and an end time for the highlight. In one embodiment, multiple highlight periods may be associated with a single highlight stream (e.g., different segments of the same video or segments of different videos). In one embodiment, highlight periods include metadata pertaining to the associated user characteristics.

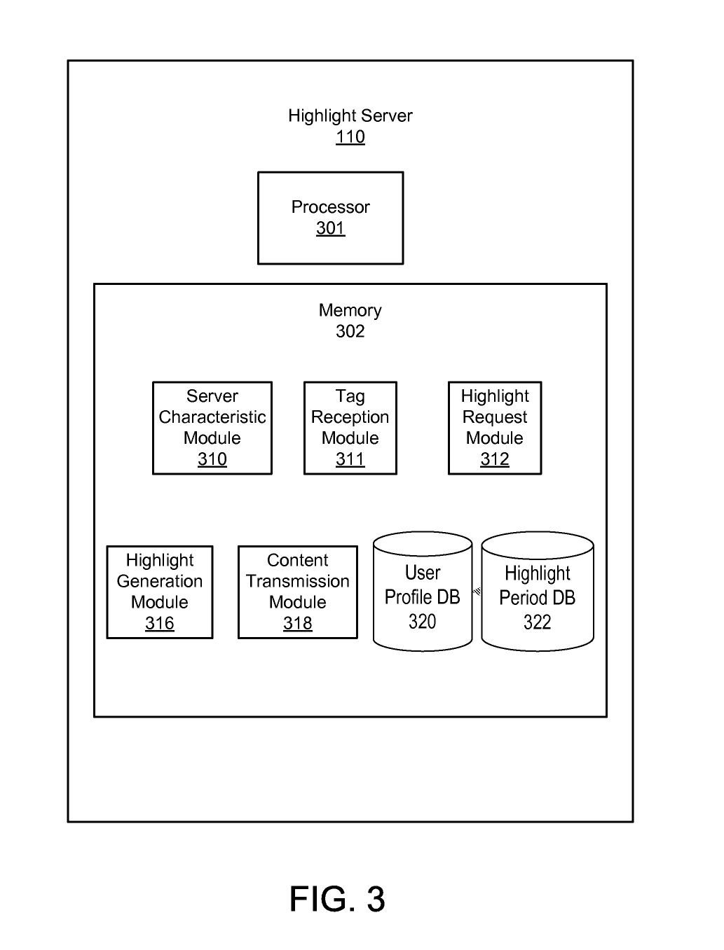

FIG. 3 illustrates a detailed view of the highlight server 110 according to one embodiment. The highlight server 110 comprises a processor 301 and a memory 302 according to one embodiment. The memory 302 stores modules comprising computer-executable program instructions executed by the processor to achieve the functionality attributed to the modules. In one embodiment, the modules in the memory 302 comprise a server characteristic module 310, a tag reception module 311, a highlight request module 312, content retrieval module 314, highlight generation module 316, content transmission module 318, user profile database 320 and highlight period database 322. In alternative embodiments, different or additional components may be included.

The user profile database 320 is configured to store user information for users registered with the highlight server 110 and user characteristics anonymously associated with each of the users. As previously described, the user characteristics may include television shows, actors, movies, sports, athletes, age, location or other items that are associated with the user.

The tag reception module 311 is configured to receive tagged highlight periods from the client 130 and store them in the highlight period database 322. In one embodiment, a highlight period identifies specific media content, a start time, a stop time, and associated characteristics. If no stop time is provided in the received highlight period, a stop time may be assigned as an increment of the given start time. Alternatively, if no stop time is provided, stored highlight periods in the highlight period database 320 may be analyzed to identify a common stop time for highlight periods with similar start times. In other embodiments, the highlight period may not identify start and/or stop times. For example, the highlight period may include information identifying a plurality of small segments (e.g., individual video files making up the overall stream in a HLS implementation) that are used in a highlight according to one embodiment. In one embodiment, the associated characteristics are explicitly identified in the highlight period received from the client 130. The highlight period database 322 may also store the number of times that the same or similar highlight periods have been tagged by users. In addition to the start and stop time of media content, the stored highlight period may include characteristics that are associated with the highlight period. For example, the user may have manually associated the characteristics “Tiger Woods”, “Golf”, and “The Masters” with a certain highlight period. In another embodiment, characteristics may be automatically assigned to a highlight period by the highlight server 110. In one embodiment, the highlight period database 322 also stores and associates a user that created the highlight period with each of the stored highlight periods.

The tag reception module 311 may also retrieve characteristics from the user profile database 320 associated with the user that submitted the highlight period. The retrieved characteristics that are associated with the received highlight period may be filtered based on the content of the media such as type of video, genre of music and sports or teams involved. Alternatively, the tag reception module 311 may refer to previously stored highlight periods associated with the same media content and filter retrieved characteristics based on the characteristics associated with the previously stored highlight periods. After identifying appropriate characteristics, the tag reception module transmits the highlight period to the highlight period database 322 for storage.

The server characteristic module 310 is configured to receive user characteristics from the user preference module 210 of the client 130. As previously described, user characteristics may be manually input by the user on client 130 or retrieve from a social network associated with the user. If retrieved from a social network, the retrieval may be performed by the client 130, the highlight server 110 or another designated entity. After receiving characteristics from the client 130, the server characteristic module 310 updates the user profile database 320 to associate the received characteristics with a user.

The highlight request module 312 is configured to receive a highlight request for a highlight stream from the client 130. In one embodiment, a highlight request includes one more pieces of media content from which highlights should be generated and characteristics on which the highlights should be based. For example, the highlight request may identify three episodes of a television show and include a characteristic of an actor or character in the show. In one embodiment, the highlight request may not identify specific media content from which to generate highlights. Similarly, the highlight request may not identify characteristics on which highlight generation should be based. In one embodiment, a highlight request may also include other filters including date of creation, duration or other descriptions of media content. Additionally, the highlight request may indicate a desired length of the resulting highlight stream. In one embodiment, a highlight request includes an indication that the highlight stream should be generated solely from highlight periods tagged by the user. This allows the user to manually select highlight periods that are included in the highlight stream regardless of other users' tagged highlight periods.

The highlight generation module 316 is configured to generate highlight streams based on the received highlight request. If the received highlight request does not include an indication of one or more media content from which a highlight stream should be generated, one or media content are selected based on characteristics associated with the user in the user profile database 320 or characteristics included in the received highlight request and filters included in the received highlight request. After identifying media content from which a highlight stream will be generated, the highlight generation module 316 retrieves the identified media content from the content server 120.

The highlight generation module 316 analyzes the retrieved media content to identify appropriate highlights for inclusion in a highlight stream. Identification of appropriate highlights is based on characteristics included in the highlight request from client 130 or characteristics stored in the user profile database 320 and associated with the user. These characteristics are compared to the characteristic associated with stored highlight periods in the highlight period database 322. Highlight periods that are from the requested media content and with characteristics similar to those in the highlight request or associated with the user are added to a generated highlight stream. In one embodiment, the duration of the highlight stream may be limited according to a preference from the user in the highlight request. In one embodiment, the media content from which highlight streams are live events, or in progress and not completed at the time of highlight stream generation.

In one embodiment, generating a highlight stream comprises sending a URL to a client, a portion of the URL including indication of an offset to be applied to a video. The offset allows the various highlights to be played for various clients from the same video. For example, all clients may be directed to a video of the entirety of a basketball game by a URL. Depending on a parameter included in the URL, each of the clients may begin playback of the basketball game at a different time period of the basketball game.

Content transmission module 318 is configured to stream generated highlight streams to the client 130 that requested the generated highlight stream. The streaming process is similar to that performed by the content server 120. In one embodiment, the content transmission module may transmit the generated highlight stream, or highlight information enabling the content server 120 to compile the highlight stream from the stored media content on the content server 120, and the content server 120 transmits the highlight stream to the client 130. For example, the content transmission module 318 may provide a playlist including identifiers identifying a sequence of clips that the content server 120 should provide to the requesting client 130. In one embodiment, a generated highlight stream, or highlight information, is transmitted to content server 120 for storage after generation. This allows the generated highlight stream to be used again without duplicate generation for the same user or other users with similar highlight requests and/or user preferences in the user profile database 320.

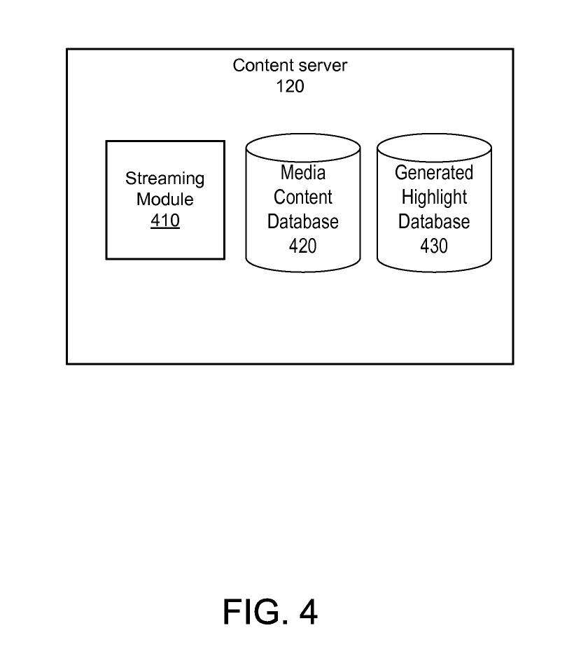

FIG. 4 illustrates a detailed view of the content server 120 according to one embodiment. In one embodiment, the content server 120 comprises a streaming module 410, a media content database 420 and a generated highlight database 430. In alternative embodiments, different or additional components may be included.

The media content database 420 stores media content provided by a content source. The stored media content can include various types of media including television show episodes, movies, sporting events and concerts. The generated highlight database 430 includes generated highlight streams or highlight information allowing reconstruction of a highlight stream. In one embodiment, highlight information for a specific stream includes a playlist or map identifying of one or more media content stored in the media content database 420 and start and stop points indicating which portions of the media content should be included in the highlight stream. In one embodiment, each of the stored generated highlight streams is associated with a highlight identifier (ID).

Streaming module 410 is configured to fulfill stream requests from the client 130 or the highlight server 110. For example, if the client 130 sends a request for certain media content stored in the media content database 420, the media content is streamed to the client 130. Alternatively, for live events, the streaming module 410 may stream content directly from a video capture source. In one embodiment, the client 130 may send a request to the content server 120 for media content stored in the content database or for a previously generated highlight stream stored in the generated highlight database. The client 130 may request highlight streams originally generated for various clients and users. For example, a first user may provide a URL to a second user which causes a request to the content server 120 for the stored generated highlight stream associated with a certain highlight identifier. A highlight stream may then be shared between users by sending the link to one another. Additionally, a highlight stream may be shared over various social networks. In one embodiment, a user may share a highlight stream with users on a social network who have similar characteristics on the social network. For example, a user may share a basketball highlight stream to all of their friends on a social network who like basketball. The content server 120 then streams the highlight stream associated with the highlight identifier to the second user. In this manner, the first user can share a highlight stream that has been customized for the first user with a second user. Streaming module 410 may also stream live events from data stored in the media content database 420 or originating elsewhere. In one embodiment, past portions of streamed live events are stored in the media content database 420 for inclusion in highlight streams.

### Example Operation and Use

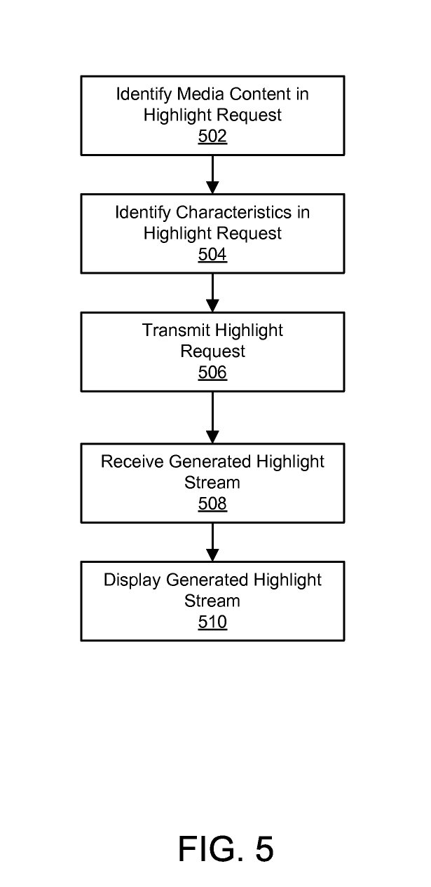

FIG. 5 illustrates an embodiment of a process for requesting a highlight stream from the highlight server 110 for playback on a client 130. The client 130 identifies 502 media content for inclusion in a highlight request. One or more pieces of media content (e.g., corresponding to a particular event, movie, show, or broadcast) may be selected from which a highlight stream is to be generated. For example, the user may select “2012 U.S. Open.” Additionally or alternatively, various filters may be applied to selected content based on date of occurrence/creation, duration, etc. For example, the client 130 may include media content with “New York Mets” in the title, but filter to include media content with a duration over 2 hours and created in the past week to attempt to include New York Mets baseball games from the past week in the media content from which a highlight stream will be generated. The client 130 identifies 504 characteristics of particular video segments that should be included in the highlight request. For example, after requesting highlights from certain sporting events, the client 130 may identify one or more athletes to include as characteristics which the highlight stream generation should be based on. The client 130 then transmits 506 the highlight request to the highlight server 110. The client 130 receives 508 the generated highlight stream transmitted by the highlight server 110. The client 130 displays 510 the received highlight stream.

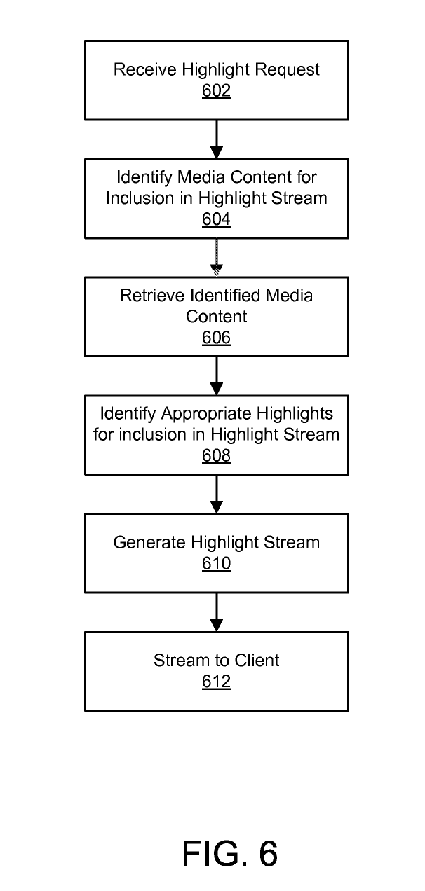

FIG. 6 illustrates an embodiment of a process for generating a highlight stream on the highlight server and streaming the highlight stream to a client. The highlight server 110 receives 602 a highlight request from a client 130. The highlight server 110 identifies 604 media content for inclusion in the highlight stream based on the highlight request and/or user characteristics. The user characteristics on which the highlight stream is based may be included in the highlight request or retrieved from the user profile database 320. The highlight server retrieves 606 identified media content from the content server 120. The highlight server identifies 608 appropriate highlights for inclusion in the highlight stream based on characteristics from the highlight request and/or the user profile database 320. The highlight server generates 610 the highlight stream and streams 612 the generated highlight stream to the client 130.

### Additional Considerations

It is noted that terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for generating collaborative video highlights disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for generating media highlights, the method comprising:
receiving from a plurality of client computers a plurality of tagged highlight periods pertaining to media content, each of the plurality of tagged highlight periods identifying a time-localized segment of media content and associated with one or more tagged characteristics;
receiving a highlight request for a highlight stream from a client computer, the highlight request including an identifier of requested media content;
identifying user profile information pertaining to a user of the client computer, the user profile information including characteristics of the user;
determining a plurality of user-requested highlight periods for inclusion in the highlight stream generated from the requested media content based on the user profile information, the plurality of user-requested highlight periods selected from the plurality of tagged highlight periods based on matching the characteristics of the user with the one or more tagged characteristics associated with each of the plurality of tagged highlight periods;
generating the highlight stream from the requested media content based on the plurality of user-requested highlight periods; and
transmitting the highlight stream to the client computer.

2. The method of claim 1, wherein identifying user profile information pertaining to the user comprises retrieving the user profile information from a social network.

3. The method of claim 1, wherein each of the one or more tagged characteristics is an identification of an entity or action occurring in a video or image.

4. A computer-implemented method for generating media highlights, the method comprising:
receiving a plurality of tagged highlight periods, each of the plurality of tagged highlight periods identifying a time-localized segment of media content;
receiving a highlight request for a highlight stream from a client computer, the highlight request including an identifier of requested media content;
identifying user profile information pertaining to a user of the client computer;
determining a user-requested highlight period for inclusion in the highlight stream generated from the requested media content based on the user profile information, the user-requested highlight period selected from the plurality of tagged highlight periods;
generating the highlight stream from the requested media content based on the user-requested highlight period; and
transmitting the highlight stream to the client computer.

5. The method of claim 4, wherein the highlight request further includes a requested duration, the requested duration indicating a desired length of the highlight stream.

6. The method of claim 4, wherein the highlight request further includes requested characteristics and wherein identifying user profile information comprises retrieving the requested characteristics.

7. The method of claim 4, wherein identifying user profile information pertaining to the user comprises retrieving characteristics from a profile database.

8. The method of claim 4, wherein the plurality of tagged highlight periods are received from a plurality of client computers.

9. The method of claim 8, further comprising:
associating tagged characteristics with each of the plurality of tagged highlight periods based on each of the plurality of client computers from which the plurality of tagged highlights were received.

10. The method of claim 4, wherein identifying user profile information pertaining to the user comprises retrieving the user profile information from a social network.

11. The method of claim 4, further comprising:
storing the transmitted highlight stream for later transmission.

12. The method of claim 4, further comprising:
receiving a request from the client computer to share the highlight stream by transmitting the highlight stream to a second client computer.

13. The method of claim 4, wherein the media content is a live event that is in progress when the highlight request is received.

14. A computer system for generating media highlights, the system comprising a non-transitory computer readable medium storing instructions for:
receiving a plurality of tagged highlight periods, each of the plurality of tagged highlight periods identifying a time-localized segment of media content;
receiving a highlight request for a highlight stream from a client computer, the highlight request including an identifier of requested media content;
identifying user profile information pertaining to a user of the client computer;
determining a user-requested highlight period for inclusion in a highlight stream generated from the requested media content based on the user profile information, the user-requested highlight period selected from the plurality of tagged highlight periods;
generating the highlight stream from the requested media content based on the user-requested highlight period; and
transmitting the highlight stream to the client computer.

15. The computer system of claim 14, wherein the highlight request further includes a requested duration, the requested duration indicating a desired length of the highlight stream.

16. The computer system of claim 14, wherein the highlight request further includes requested characteristics and identifying user profile information comprises retrieving the requested characteristics.

17. The computer system of claim 14, wherein identifying user profile information pertaining to the user comprises retrieving characteristics from a profile database.

18. The computer system of claim 14, wherein the plurality of tagged highlight periods are received from a plurality of client computers.

19. The computer system of claim 18, further comprising instructions for:
associating tagged characteristics with each of the plurality of tagged highlight periods based on each of the plurality of client computers from which the plurality of tagged highlights were received.

20. The computer system of claim 14, wherein identifying user profile information pertaining to the user comprises retrieving the user profile information from a social network.

21. The computer system of claim 14, further comprising instructions for:
storing the transmitted highlight stream for later transmission.

22. The computer system of claim 14, further comprising instructions for:
receiving a request from the client computer to share the highlight stream by transmitting the highlight stream to a second client computer.

23. The computer system of claim 14, wherein the media content is a live event that is in progress when the highlight request is received.
